(19) United States
(12) Patent Application Publication
(10) Pub. No.: US 2008/0303004 A1
(43) Pub. Date: Dec. 11, 2008

(54) Method for producing lithium transition metal polyanion powders for batteries

(75) Inventor: Zhenhua Mao, Ponca City, OK (US)

Correspondence Address: ConocoPhillips Company - IP Services Group;Attention: DOCKETING, 600 N. Dairy Ashford, Bldg. MA-1135, Houston, TX, 77079, US

(73) Assignee: CONOCOPHILLIPS COMPANY, Houston, TX (US)

(21) Appl. No.: 12/024,023

(22) Filed: Jan. 31, 2008

Related U.S. Application Data
(60) Provisional application No. 60/933,915, filed on Jun. 8, 2007.

(51) Int. Cl. H01B 1/02

(52) U.S. Cl. 252/518.1; 252/520.4

(57) ABSTRACT

This invention relates to a process for producing an improved powder for the positive electrode of lithium ion batteries wherein the powder comprises lithium, vanadium and phosphate. The process includes forming a suspension of the precursors with a high boiling temperature solvent and heating the suspension to a reaction temperature of between 250° C. and 400° C. to convert the precursors to the desired solid product. The solid product is separated from the suspension and is heated to a higher temperature to crystallize the product. The resulting product retains a small particle size thus avoiding the need for milling or other processing to reduce the product to a particle size suited for batteries.

### CROSS-REFERENCE TO RELATED APPLICATIONS

This application claims the benefit of U.S. provisional patent application Ser. No. 60/933,915, filed Jun. 8, 2007.

### STATEMENT REGARDING FEDERALLY SPONSORED RESEARCH OR DEVELOPMENT

None

### FIELD OF THE INVENTION

This invention relates to materials for use in the positive electrode of lithium-ion batteries and processes for making such materials.

### BACKGROUND OF THE INVENTION

Lithium-ion batteries are recognized and valued for high efficiency, energy density, high cell voltage and long shelf life and have been in commercial use since the early 1990's. As always though, there is a desire to make better batteries for less cost.

A key component of current lithium-ion batteries is a lithium transition metal polyanion salt powder that is provided as the active material on the metal plates of the positive electrode. Iron, cobalt, manganese, and nickel powders have been used and other transition metals have been considered. Cobalt has high performance but has proven to be unsafe because of the potential for explosion during recharging. Iron is attractive because of its low cost, but does not provide the specific energy density of other transition metal compounds such as LiCoO₂ and LiNiO₂ etc. Vanadium has been proposed, but has yet to be used commercially, probably because of the higher expense and limited success in obtaining any advantage over other, more developed systems.

Many methods have been investigated to synthesize various lithium transition metal polyanion salt powders. These methods include solid-state reactions, carbon thermal reduction, and hydrogen reduction methods. However, there are several problems with each of these methods. The major problems include a) agglomeration of particles, b) incomplete reactions, c) the existence or presence of undesirable components within the starting materials and their subsequent presence in the final products, d) poor electrochemical properties of the resulting materials, and e) the requirement for expensive precursors and/or complicated processes.

Lithium transition metal polyanion salt powders are most typically synthesized using a solid state reaction. Precursors in the form of solid particles are mixed to produce an intimate mixture of particles. When heat is applied to effect reaction, the solid particles react with one another through a variety of surface reactions accompanied by diffusion of reactive materials into and out of the various particles in the mixture. For this reason, it is preferred to first provide particles of the desired particle size and then mix these particles to create a mixture with the precursors highly dispersed throughout to obtain a high degree of contact between the precursors for a high yield of the desired product. To accomplish this, the particle mixtures are typically prepared by methods such as ball-milling and/or physical mixing. Since the active material particles may be relatively large and/or the sizes may be non-uniform, optimum conditions of surface to surface contact between particles is often not well achieved.

For these above reasons, it would be desirable to provide a better method for synthesizing lithium transition metal polyanion salt powders.

U.S. Pat. No. 5,910,382 to Goodenough et al. (hereafter “Goodenough”) describes improvements to cathode materials for rechargeable lithium batteries and especially the inclusion of oxide polyanions such as (PO₄)³⁻. While Goodenough seems to prefer manganese, iron, cobalt and nickel, Goodenough notes that vanadium is a cheaper and less toxic transition metal than the already developed systems using cobalt, nickel and manganese.

U.S. Pat. No. 5,871,866 to Barker et al (hereafter “Barker”) describes a number of lithium transition metal oxide formulations for use in the cathode of lithium-ion batteries. Lithium vanadium phosphate [Li₃V₂(PO₄)₃ or “LVP”] is one of the specifically discussed examples.

Barker and Goodenough each describe processes for producing cathode powders comprising a solid state reaction described above wherein the precursors are intermingled to form an essentially homogenous powder mixture. There is discussion in each describing the powder precursors being pressed into pellets to get better grain to grain contact and several intermittent milling steps during synthesis of the materials.

U.S. Pat. No. 6,913,855 to Stoker et al (hereafter “Stoker”) also describes an array of lithium transition metal oxide formulations for use in the cathode of lithium-ion batteries including LVP. Stoker blends the precursors in a slurry that may include a solvent with some precursors being partially dissolved in the solvent. The slurry apparently creates the highly dispersed precursors which is then spray dried prior to starting the reaction to produce the desired product. Like Barker, one option to get the high degree of contact required for a high yield of the desired product is to compress the spray dried powder into tablets prior to starting the reaction.

### SUMMARY OF THE INVENTION

The present invention improves the state of the art of batteries and materials useful in the production of batteries. More specifically, the present invention provides an improved method for the production of lithium vanadium phosphate [Li₃V₂(PO₄)₃] powder.

### BRIEF DESCRIPTION OF THE DRAWINGS

The invention, together with further advantages thereof, may best be understood by reference to the following description taken in conjunction with the accompanying drawings in which:

FIG. 1 is a block diagram showing a first embodiment of the inventive process for making LVP powders;

FIG. 2 is a block diagram showing a second embodiment of the inventive process for making LVP powders.

FIG. 3 is a block diagram showing a third embodiment of the inventive process for making a carbon coated LVP (CVLP) powders;

FIG. 4 is a graph comparing the discharge capacities of LVP and CLVP powders made according to the present invention.

FIG. 5a is a graph comparing the electrode potential profiles at the first cycle for LVP and CLVP powders made according to the present invention.

FIG. 5b is a graph comparing the electrode potential profiles at the tenth cycle for LVP and CLVP powders made according to the present invention.

FIG. 6a is a graph comparing the electrode potential profiles during the first cycle for CLVPs made with different levels of pitch coating according to the present invention.

FIG. 6b is a graph comparing the electrode potential profiles during the tenth cycle for CLVPs made with different levels of pitch coating according to the present invention.

FIG. 7 is a graph comparing the discharge capacities at different cycle numbers for CLVPs made with different levels of pitch coating according to the present invention.

FIG. 8 is a scanning electron micrograph of a CLVP powder according to the present invention.

### DETAILED DESCRIPTION OF THE INVENTION

This invention includes several facets or aspects. To aid in the discussion and understanding of the invention as it relates to various parameters and qualities for batteries, several definitions are provided for comparison of the materials of the present invention with prior art materials or materials from prior art methods.

As used herein, the following terms have their usual meanings in the art and are intended to specifically include the following definitions:

A “cell” is the basic electrochemical unit used to generate or store electrical energy.

A “battery” is two or more electrochemical cells electrically interconnected in an appropriate series/parallel arrangement to provide the required operating voltage and current levels. Under common usage, the term “battery” is also applied to a single cell device.

The “cathode” is the electrode in an electrochemical cell where reduction takes place. During discharge, the positive electrode of the cell is the cathode. During charge, the situation reverses, and the negative electrode of the cell is the cathode.

“Capacity” (mAh/g) is the amount of electrical charge that can be stored in and released from a given electrode material per unit weight within a certain defined electrode potential window.

“Capacity Fade” or “Fading” is the gradual loss of capacity of a rechargeable battery with cycling. Synonymous with “Capacity Loss”

“Coulombic Efficiency (%)” is the ratio of the amount of electrical charge discharged from an electrode material to the amount of electrical charge used to charge the electrode to the state before discharge.

“Electrode Potential” is the electrical voltage between the electrode of interest and another electrode (reference electrode).

“Stabilization” is a process which renders particles of a carbon-residue-forming material (CRFM) infusible such that the surface of the CRFM particles does not soften or melt and fuse to adjacent CRFM particles during subsequent heat treatments as long as the temperature of the subsequent heat treatment does not exceed the instantaneous melting point of the stabilized CRFM.

“Carbonization” is a thermal process that converts a carbon containing compound to a material that is characterized as being “substantially carbon”. “Substantially carbon”, as used herein, indicates that the material is at least 95% carbon by weight.

A “carbon-residue-forming material” (CRFM) is any material which, when thermally decomposed in an inert atmosphere to a carbonization temperature of 600° C. or an even greater temperature, forms a residue which is “substantially carbon”.

Turning now more specifically to the invention, this invention relates to a method for making fine Li₃V₂(PO₄)₃ (LVP) powders, i.e., powders having a small particle size. The fine LVP powder is particularly useful as a material for the positive electrode of high power lithium-ion batteries. In this invention, preferred embodiments of these powders are produced with a carbon-coating which we describe as CLVP. It is believed that CLVP powders have improved efficiency, capacity and stability compared with other cathode powders. It is further believed that lithium-ion batteries made with the CLVP from this invention have improved performance as compared with lithium-ion batteries made with other cathode powders.

The present invention for producing LVP comprises a process for forming a suspension of the precursors with a high boiling temperature solvent and driving the reaction to form the desired LVP product in liquid solution. The reaction occurs at temperatures above about 50° C. up to about 400° C., although a maximum temperature of less than about 300° C. is preferable, and a maximum temperature of less than about 250° C. is more preferable. As the LVP forms, it precipitates out of solution. Suitable solvents are any polar organic compounds or mixtures of polar organic compounds in which the reaction precursors have a certain solubility and that are thermally stable within the desired temperature range. Examples of suitable solvents include different alcohols, acids, nitrites, amines, amides, quinoline, and pyrrolidinones, etc. and mixture of these solvents. Specific examples include 1-heptanol, propylene carbonate, ethylene carbonate, diethylenetriamine, and NMP (n-methyl-pyrrolidone, 1-methyl-2-pyrrolidinone, or 1-methyl-2-pyrrolidone), and any combination of these solvents. It is preferred that the boiling point of the solvent be at least 20° C. and more preferably above 100° C. The most preferable solvents are polar solvents which have a boiling point greater than that of water and are non-reactive with the precursors. Preferred solvents are also miscible with water. Polar solvents such as NMP, which has a boiling point of 202° C., are preferred.

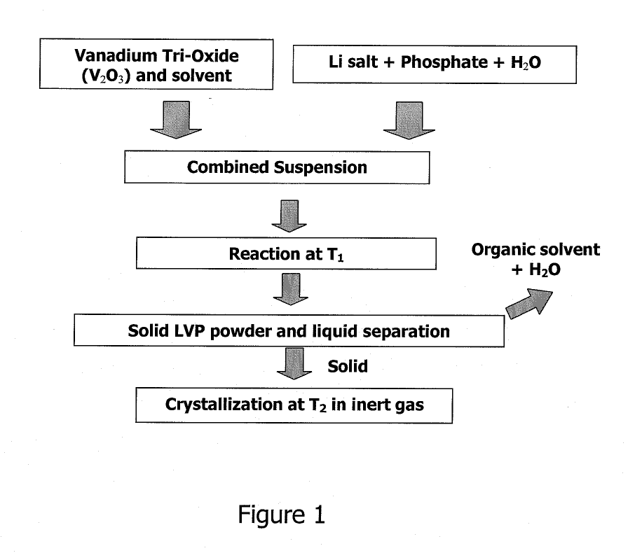

FIG. 1 shows the process flow diagram according to a first embodiment of the invention. A suspension is made with vanadium trioxide and a solvent. A first solution is made with a phosphate or other polyanion, a lithium salt and water. The vanadium trioxide suspension and first solution are combined to form a second suspension. The second suspension is agitated continuously while being heated to a first temperature, T₁, to drive the reaction to form LVP precipitate.

The preferred precursors are three valence vanadium trioxide (V₂O₃) powders as the vanadium source, lithium carbonate (Li₂CO₃) or lithium hydroxide (LiOH) as the lithium source, and phosphoric acid (H₃PO₄) as the phosphate source. Ammonium hydrate phosphate ((NH₄)₂HPO₄) or ammonium phosphate NH₄H₂PO₄ can also be used as the phosphate or polyanion source. One of ordinary skill in the art will recognize that there are a large number of polyanion-containing compounds which could be used as source of the polyanions required in the final lithium vanadium polyanionic product. Even though there is not any specific requirement for the particle size of vanadium oxide powder, the vanadium trioxide powder precursor is preferably milled to an average particle size of less than 30 micrometers, and more desirably less than 20 micrometers, to increase the reaction rate. The lithium precursor typically dissolves in the solvent/water solution.

After the precursors and solvent are mixed, the resulting suspension is heated in an inert atmosphere, such as nitrogen, helium, carbon monoxide, or carbon dioxide gas, etc., while the mixture is agitated. The suspension is heated to a temperature (T₁) as high as 400° C., but is preferably below 300° C., even more preferably below 250° C. The heating causes the precursors to react and form the desired compound, Li₃V₂(PO₄)₃, which precipitates out of the solution upon formation. A significant feature of the inventive process is that the presence of the polar solvent prevents the particles of Li₃V₂(PO₄)₃ from growing to a large size and prevents the particles from agglomerating and the Li₃V₂(PO₄)₃ remains as a loose (flowable) powder following separation from the solution.

Any conventional method for solid-liquid separation, such as, for example, centrifugal separation, or filtration, can be used to separate the LVP from the solution. Where the precursor materials are of high quality and contain few or no impurities that would be deleterious to the final product, separation can be achieved by simply evaporating the solvent during the subsequent crystallization step.

Referring back to FIG. 1, the LVP is then subjected to a higher temperature, T₂, to form the desired crystalline structure. The crystallization step involves heating the reacted product at a temperature higher than 400° C. in an inert atmosphere. The heating temperature should be between 400 and 1000° C., and preferably between 500 and 900° C., and more preferably between 500 and 850° C. The resulting product remains as a loose (flowable) powder comprised of at least 99% Li₃V₂(PO₄)₃.

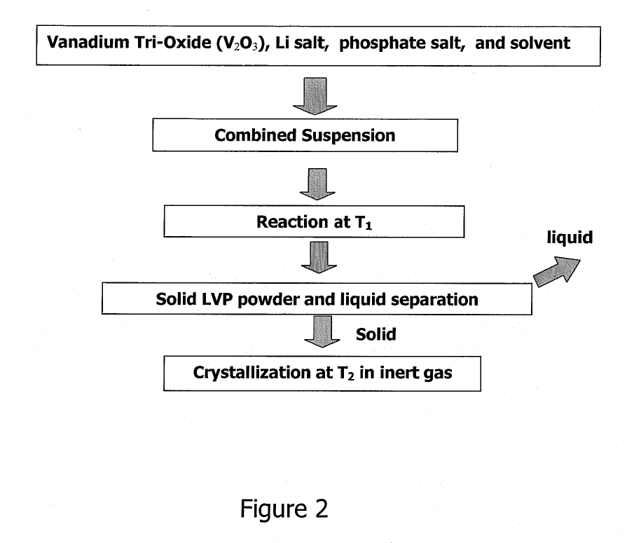

FIG. 2 illustrates a second embodiment of the inventive process. In the second embodiment, all of the precursors (vanadium trioxide, a lithium salt and phosphate) are combined with a solvent, and water as needed, to make a single suspension. The resulting suspension is agitated continuously while being heated to a first temperature, T₁, to drive the reaction to form LVP precipitate. After separation from the suspension the Li₃V₂(PO₄)₃ remains as a powder. The LVP is then subjected to a higher temperature, T₂, to crystallize the LVP. The processes for separating the LVP from the suspension and for crystallizing the LVP prepared according to the second embodiment are the same as the processes for separating and crystallizing the LVP prepared according to the first embodiment.

These new processes for making LVP produce a different and better LVP than LVP produced by the solid state synthesis methods described in the prior art. First, since the inventive process is performed in a suspension and not as a solid state reaction, the size of the LVP particles can be easily and economically produced at the small uniform sizes desirable for commercial battery production. The desired particle size for LVP intended for use in high power batteries is less than 10 μm, and is preferably below 1 μm. In solid state reaction processes, the pellets or tablets must be extensively milled or otherwise processed after completion of the solid state reaction to produce particles of a reasonably uniform size suitable for use by a commercial battery manufacturer. The additional step of milling or processing increases the time and cost when considering the total cost of production. Because the concentration of reactants affects the reaction rate, the particle size of the resulting solid, and agglomeration of the resulting particles, the inventive method can naturally produce LVP particles smaller than 1 μm without additional milling or further processing steps.

Another significant benefit of the inventive method for producing LVP is that contaminants, impurities or non-desired materials are less likely to be present in the final product. Most of the non-desired materials are separated from the intermediate solid product when it is separated from the solvent because most of the impurities will remain dissolved in the solution. In a solid state reaction, contaminants, impurities or non-desired materials contained in the precursors, or produced as by-products of the reaction, are more likely to be carried into the final product.

Another advantage of the present invention is that lower cost precursors may be used in the production of the LVP. Specifically, the preferred precursors include lithium carbonate (Li₂CO₃), phosphoric acid (H₃PO₄) and vanadium trioxide (V₂O₃). Lithium carbonate and phosphoric acid are the least costly sources of lithium and phosphate, and vanadium trioxide has a high vanadium content and is a low cost material compared with most of the other vanadium compounds suitable as the source of vanadium. Considering that nearly all of the precursors are converted to the final product, the inventive process should provide LVP and other cathode powder products at a lower cost compared to known techniques for producing these compounds.

As noted above, an additional aspect of the invention is the CLVP where the LVP is coated with carbon. This coating provides enhanced electrical conductivity that is necessary for the lithium intercalation process on the positive electrode side of a lithium-ion battery. Many prior art lithium-ion batteries physically mix carbon black or other carbonaceous powders, such as graphite, with the lithium transition metal powder to provide the necessary electrical conductivity. Coating the LVP with carbon has several advantages in that it seems to be optimal to have a very thin coating so most of the weight and volume of the cathode material is in the LVP and it is intrinsically part of the powder. Preferred loading of the carbon coating on the CLVP is at least 0.1% up to about 10% by weight, preferably between about 0.5% and about 5% by weight, more preferably between about 0.5% and about 3% by weight, and even more preferably between about 1% and about 2.5% by weight.

Other processes for making LVP require that carbon black or other carbonaceous materials be mixed with the LVP to provide the level of electrical conductivity required for good performance. This increases both the volume and weight of the battery and results in a battery which is larger and heavier compared to a battery with similar performance made from CLVP.

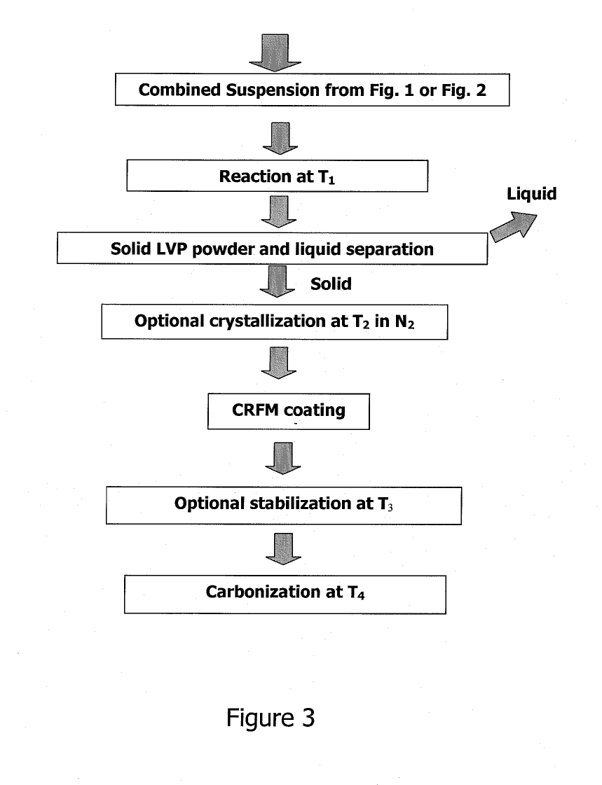

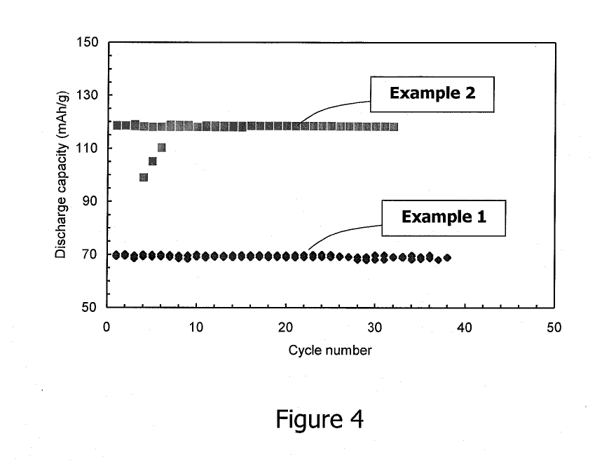

FIG. 3 shows the process flow diagram according to this embodiment of the invention. The process consists of the steps set forth to produce the LVP as described above and illustrated in FIGS. 1 and 2, but continues with several additional steps.

The additional steps include the LVP being subjected to a carbon-coating or pitch-coating step which involves coating the reacted LVP particles from the crystallization step above with a carbon-residue-forming material (CRFM). After the CRFM coating is deposited on the surface, the coated powder is separated from the solvent and any CRFM remaining in the solvent and dried. The dried coated LVP powder is heated to a temperature of between about 500° C. and about 1000° C., preferably between about 700° C. and about 900° C., more preferably between about 800° C. and about 900° C. to convert the CRFM to carbon. The resulting powder is carbon-coated LVP or CLVP. In this embodiment, the crystallization step at T₂ is optional and can be omitted. Therefore, the heating process at T₄ achieves both conversion of the CRFM to carbon and the crystallization of the LVP. Before the final heat-treatment at T₄, an optional heat-treatment step at T₃, referred to hereinafter as stabilization, may be performed to prevent melting or fusion of coated CRFM.

The LVP powder may be coated with the CRFM by any suitable method. By way of non-limiting examples, useful techniques for coating the LVP powder include the steps of liquefying the CRFM by a means such as melting or forming a solution with a suitable solvent combined with a coating step such as spraying the liquefied carbonaceous material onto the LVP particles, or dipping the LVP particles in the liquefied CRFM and subsequently drying out any solvent. The CRFM may also be precipitated on the LVP powder by any suitable method to form the coated LVP powder. In an embodiment, the coated LVP powder may be formed by dispersing the LVP powder in a suspension liquid to form a LVP powder suspension. A solution containing the CRFM may then be added to the LVP powder suspension and mixed so that a portion of the CRFM may precipitate on the LVP particles in the CRFM-LVP mixture. The CRFM solution may be prepared by dissolving a carbonaceous material in a solvent.

In the preferred embodiment, a solution phase precipitation process using petroleum pitch or coal tar pitch and one or more solvents is used to coat the LVP with the CRFM.

A particularly useful method of forming a uniform coating of a CRFM is to partially or selectively precipitate the CRFM onto the surface of the LVP particles. A concentrated solution of the CRFM in a suitable solvent is formed by combining the CRFM with a solvent or a combination of solvents to dissolve all or a substantial portion of the CRFM. When petroleum or coal tar pitch is used as the CRFM, preferred solvents are cyclic and aromatic compounds, such as toluene, xylene, quinoline, tetrahydrofuran, tetrahydronaphthalene (sold by Dupont under the trademark Tetralin), or naphthalene, depending on the selected pitch. The ratio of the solvent(s) to the CRFM in the solution and the temperature of the solution is controlled so that the CRFM completely or almost completely dissolves in the solvent. Typically, the solvent to CRFM ratio is less than 2, and preferably about 1 or less, and the CRFM is dissolved in the solvent at a temperature that is below the boiling point of the solvent.

Concentrated solutions wherein the solvent-to-solute ratio is less than 2:1 are commonly known as flux solutions. Many pitch-type materials form concentrated flux solutions wherein the pitch is highly soluble when mixed with the solvent at solvent-to-pitch ratios of 0.5 to 2.0. Dilution of these flux mixtures with the same solvent or a solvent in which the CRFM is less soluble results in partial precipitation of the CRFM. When this dilution and precipitation occurs in the presence of a suspension of LVP particles, the particles act as nucleating sites for the precipitation. The result is an especially uniform coating of the CRFM on the particles.

The coating layer of the LVP particles can be applied by mixing the particles directly into a solution of CRFM. When the LVP particles are added to the solution of CRFM directly, additional solvent(s) is generally added to the resulting mixture to effect partial precipitation of the CRFM. The additional solvent(s) can be the same as or different than the solvent(s) used to prepare the solution of the CRFM.

In an alternative method to the precipitation method described above, a suspension of LVP particles is prepared by homogeneously mixing the particles in either the same solvent used to form the solution of CRFM, in a combination of solvent(s) or in a different solvent at a desired temperature, preferably below the boiling point of the solvent(s). The suspension of the LVP particles is then combined with the solution of CRFM, causing a certain portion of the CRFM to deposit substantially uniformly on the surface of the LVP particles.

The total amount and chemical composition of the CRFM that precipitates onto the surface of the LVP particles depends on the portion of the CRFM that precipitates out from the solution, which in turn depends on the difference in the solubility of the CRFM in the initial solution and in the final solution. When the CRFM is a pitch, wide ranges of molecular weight species are typically present. One skilled in the art would recognize that partial precipitation of such a material would fractionate the material such that the precipitate would be relatively high molecular weight and have a high melting point, and the remaining solubles would be relatively low molecular weight and have a low melting point compared to the original pitch.

The solubility of the CRFM in a given solvent or solvent mixture depends on a variety of factors including, for example, concentration, temperature, and pressure. As stated earlier, dilution of concentrated flux solutions causes solubility of the CRFM to decrease. Precipitation of the coating is further enhanced by starting the process at an elevated temperature and gradually lowering the temperature during the coating process. The CRFM can be deposited at either ambient or reduced pressure and at a temperature of about −5° C. to about 400° C. By adjusting the total ratio of the solvent to the CRFM and the solution temperature, the total amount and chemical composition of the CRFM precipitated on the LVP particles can be controlled.

By using a liquid phase selective precipitation technique, the total amount, chemical composition, and physical properties of the CRFM coated on the LVP powder may be controlled by the choice of CRFM, by changing the solvent used to initially dissolve the CRFM, by changing the amount of solvent used to initially dissolve the CRFM, and by changing the amount of solvent in the CRFM-LVP mixture. The amount of solvent used may be any amount suitable to provide a desired coating. In certain embodiments, the weight ratio of CRFM to solvent may be between about 0.1 to about 2, alternatively between about 0.05 and about 0.3, or more particularly between about 0.1 and about 0.2.

It is to be understood that the CRFM provided as the coating for the LVP may be any material which, when thermally decomposed in an inert atmosphere to a carbonization temperature of 600° C. or greater temperature forms a residue which is “substantially carbon”. It is to be understood that “substantially carbon” indicates that the residue is at least 95% by weight carbon. Preferred for use as coating materials are CRFMs that are capable of being reacted with an oxidizing agent. Preferred compounds include those with a high melting point and a high carbon yield after thermal decomposition. Without limitation, examples of CRFMs include petroleum pitches and chemical process pitches, coal tar pitches, lignin from pulp industry; and phenolic resins or combinations thereof. In other embodiments, the CRFM may comprise a combination of organic compounds such as acrylonitrile and polyacrylonitriles; acrylic compounds; vinyl compounds; cellulose compounds; and carbohydrate materials such as sugars. Especially preferred for use as coating materials are petroleum and coal tar pitches and lignin that are readily available and have been observed to be effective as CRFMs.

Any suitable solvent may be used to dissolve the carbonaceous material. Without limitation, examples of suitable solvents include xylene, benzene, toluene, tetrahydronaphthalene (sold by Dupont under the trademark Tetralin), decaline, pyridine, quinoline, tetrahydrofuran, naphthalene, acetone, cyclohexane, ether, water, n-methyl-pyrrolidone (NMP), carbon disulfide, or combinations thereof. The solvent may be the same or different than the suspension liquid used to form the LVP powder suspension. Without limitation, examples of liquids suitable for suspension of the LVP powder include xylene, benzene, toluene, tetrahydronaphthalene, decaline, pyridine, quinoline, tetrahydrofuran, naphthalene, acetone, cyclohexane, ether, water, n-methyl-pyrrolidone (NMP), carbon disulfide, or combinations thereof.

Additional embodiments include increasing the temperature of the CRFM solution prior to mixing with the LVP powder suspension. The CRFM solution may be heated to temperatures from about 25° C. to about 400° C., alternatively from about 70° C. to about 300° C. Without being limited by theory, the temperature may be increased to improve the solubility of the CRFM. In an embodiment, the LVP powder suspension and/or the CRFM solution may be heated before being mixed together. The LVP powder suspension and CRFM solution may be heated to the same or different temperatures. The LVP powder suspension may be heated to temperatures from about 25° C. to about 400° C., alternatively from about 70° C. to about 300° C. In another embodiment, after the LVP powder suspension and the CRFM solution are mixed together, the CRFM-LVP mixture may be heated. The CRFM-LVP mixture may be heated to temperatures from about 25° C. to about 400° C., alternatively from about 70° C. to about 300° C.

The temperature of the CRFM-LVP mixture may be reduced so that a portion of the CRFM precipitates on to the LVP powder to form a coating of CRFM. In particular embodiments, the CRFM-LVP mixture may be cooled to a temperature between about 0° C. and about 100° C., alternatively between about 20° C. and about 60° C.

Once coated, the coated LVP powder may be separated from the CRFM-LVP mixture by any suitable method. Examples of suitable methods include filtration, centrifugation, sedimentation, and/or clarification.

In certain embodiments, the coated LVP powder may be dried to remove residual solvent on the coated particles. The coated LVP powder may be dried using any suitable method. Without limitation, examples of drying methods include vacuum drying, oven drying, air drying, heating, or combinations thereof.

In some embodiments, the coated LVP powder may be stabilized after separation from the CRFM-LVP mixture. Stabilization may include heating the coated LVP powder for a predetermined amount of time in a nearly inert (containing less than 0.5% oxygen) environment. In an embodiment, the coated LVP powder may be stabilized by raising the temperature to between about 20° C. and 400° C., alternatively between about 250° C. and 400° C., and holding the temperature between about 20° C. and 400° C., alternatively between about 250° C. and about 400° C. for 1 millisecond to 24 hours, alternatively between about 5 minutes and about 5 hours, alternatively between about 15 minutes and about 2 hours. The stabilization temperature should not exceed the instantaneous melting point of the carbonaceous material. The exact time required for stabilization will depend on the temperature and the properties of the CRFM coating.

In a preferred embodiment, the coated LVP powder may be heated in the presence of an oxidizing agent. Any suitable oxidizing agent may be used, such as a solid oxidizer, a liquid oxidizer, and/or a gaseous oxidizer. For instance, oxygen and/or air may be used as an oxidizing agent.

The coated LVP powder may then be carbonized. Carbonization may be accomplished by any suitable method. In an embodiment, the coated LVP powder may be carbonized in an inert environment under suitable conditions to convert the coating of CRFM to carbon. Without limitation, suitable conditions include raising the temperature to between about 600° C. and about 1,100° C., alternatively between about 700° C. and about 900° C., and alternatively between about 800° C. and about 900° C. The inert environment may comprise any suitable inert gas including without limitation argon, nitrogen, helium, carbon dioxide, or combinations thereof. Once carbonized, the carbon-coated LVP (CLVP) powders may be used as a material for the positive electrode in lithium ion batteries or for any other suitable use.

The various embodiments of the coating process described above may also be used to increase the battery properties of a LVP powder. In particular, the battery properties that may be increased or improved include the capacity and the coulombic efficiency of a LVP powder. In one embodiment, the capacity of a LVP powder is increased by at least about 10%, preferably by at least about 15%, more preferably by at least about 20%. In another embodiment, the coulombic efficiency of a LVP powder is increased by at least about 10%, preferably by at least about 12%, more preferably by at least about 15%.

### EXAMPLES

To further illustrate various embodiments of the present invention, the following examples are provided.

### Example 1

An LVP powder according to the present invention was made by placing 30.68 grams of vanadium trioxide powder (V₂O₃, 95%) and 100 ml of NMP (1-methyl-2-pyrrolidinone) in a milling vial and ball-milled with about one pound of ¼″ stainless steel balls for about 30 minutes. In a glass beaker, 59.575 grams of lithium acetate dihydrate (LiC₂H₃O₂.2H₂O, 99.9%) and 78.61 grams of ammonium hydrate phosphate ((NH₄)₂HPO₄, 98%) were dissolved in 100 ml of water. The V₂O₃ suspension and LiC₂H₃O₂.2H₂O/(NH₄)₂HPO₄/water solution were combined a glass flask and an additional 500 ml NMP was added to the suspension. The suspension was heated at the boiling point with constant agitation by flushing with nitrogen gas until all the solvents (NMP and water) were completely evaporated. The resulting product was a flowable powder.

The LVP powder was placed in an alumina boat and heated in a tube furnace in a nitrogen gas atmosphere in the following sequence: 3 hours at 350° C., 5 hours at 450° C., and 5 hours at 650° C. The resulting powder was placed in a plastic bottle with ⅛″ stainless steel balls and shaken. The powder was subsequently heated at 650° C. for 15 hours in nitrogen gas atmosphere.

Example 2 used the LVP powder produced by the process described in Example 1 and coated it with 2.6 wt % pitch using a petroleum pitch as the precursor. Two grams of the petroleum pitch were dissolved in about 4 grams of xylene and heated to 90° C. A suspension consisting of 7.6 grams LVP powder in 200 grams of xylene was heated to 140° C. The pitch/xylene solution was added to the powder/xylene suspension and subjected to 10 minutes of continuous agitation. The heater was subsequently removed to let the suspension cool to room temperature. The resulting solid powder was separated out by filtration, and dried at 100° C. under vacuum. The resulting powder weighed 8 grams. The pitch coating comprised about 2.6% by weight. The pitch-coated powder was placed in a tube furnace and gradually heated in a nitrogen gas atmosphere at the rate of 1° C./minute to 300° C., and maintained at 300° C. for 6 hours. The furnace was cooled down to ambient temperature and the powder was removed and blended in a plastic bottle. Subsequently, the powder was placed back in the furnace and heated in a nitrogen atmosphere according to the following sequence: 350° C. for 2 hours, 450° C. for 2 hours, and 850° C. for 5 hours. The resulting product was a loose (flowable) powder which did not require further milling.

Example 3 used the LVP powder produced by the process described in Example 1 and coated it with 2.3 wt % pitch using the same pitch as the precursor as Example 2. Seven grams of the pitch were dissolved in about 7 grams of xylene and heated to 90° C. A suspension consisting of 30 grams LVP powder in 200 grams of xylene was heated to 140° C. The pitch/xylene solution was added to the powder/xylene suspension and subjected to 10 minutes of continuous agitation. The heater was subsequently removed to let the suspension cool to room temperature. The resulting solid powder was separated out by filtration, and dried at 100° C. under vacuum. The resulting powder weighed 30.8 grams. The pitch coating comprised about 2.6% by weight. The pitch-coated powder was placed in a tube furnace and gradually heated in a nitrogen gas atmosphere at the rate of 1° C./minute to 300° C., and maintained at 300° C. for 6 hours. The furnace was cooled down to ambient temperature and the powder was removed and blended in a plastic bottle. Subsequently, the powder was placed back in the furnace and heated in a nitrogen atmosphere according to the following sequence: 350° C. for 2 hours, 450° C. for 2 hours, and 850° C. for 5 hours. The resulting product was a loose (flowable) powder which did not require further milling.

Example 4 was prepared in the same manner as Example 3, except that the amount of pitch-coating was 1.6% by weight. This was achieved by dissolving 4 grams of pitch 4 grams of xylene to coat 30 grams of the LVP powder from Example 1.

The powders made in Examples 1-4 were evaluated as the materials for the positive electrode of lithium ion batteries. First, the powders were fabricated into electrodes and tested in coin cells as described as below.

A desired amount of the powder was mixed with acetylene carbon black, fine graphite (<8 μm), and a solution of polyvinylidene fluoride (PVDF) dissolved in NMP to make a slurry. The slurry was cast on a 20 μm aluminum foil, and dried on a hot plate. The dried solid films contained 2 wt % carbon black, 4 wt % graphite, 4 wt % PVDF, and 90 wt % of the powder to be tested. The films were trimmed to 5 cm strips and pressed through a hydraulic rolling press so that the density of the solid films was about 2.1 g/cc. The thickness or the mass loading of the solid films was controlled to be about 9 mg/cm². Because the powder from Example 1 is not electrically conductive, the electrode composition was 78 wt % powder, 2 wt % carbon black, 15 wt % graphite, and 5% PVDF.

Disks measuring 1.41 cm in diameter were punched out from the pressed films and used as the positive electrode in standard coin cells (size CR2025) with lithium metal as the negative electrode. The separator used in the coin cells was a glass matt (Watman® Glass microfibre filter, GF/B), and the electrolyte was 1 M LiPF₆ in a mixture of solvents (40% ethylene carbonate, 30% methyl carbonate, and 30% diethyl carbonate).

Cells were tested according the following procedure: Each cell was charged under a constant current of 0.5 mA (˜35 mA/g) until the cell voltage reached 4.2 volts, and charged further at 4.2 volts for one hour or until the current dropped to below 0.03 mA. Then the cell was discharged at a constant current of 0.5 mA until the cell voltage reached 3.0 volts. Charge/discharge cycles were repeated to determine the stability of the materials during cycling. The capacity of the materials was calculated based on the electrical charge passed during discharging, while the coulombic efficiency was calculated based on the ratio of the amount of electrical charge discharged from the cell to the amount of electrical charge that used to charge the cell before discharge. All the tests were conducted at room temperature (˜23° C.) using an electrochemical test station (Arbin Model BT-2043).

A comparison of the capacities and coulombic efficiencies at the 1^{st} and 10^{th} cycles for the powders made in Examples 1-4 is provided in Table 1.

### Example 5

Example 5 used less expensive chemicals as the precursors than those used in Example 1. In this example, 27.46 grams of lithium carbonate (Li₂CO₃, 99%) and 83.84 grams of phosphoric acid (H₃PO₄, 86%) were dissolved in a solution consisting of 50 mls water and 50 mls NMP. Similar to Example 1, 38.71 grams of vanadium trioxide powder (V₂O₃, 95%) were milled in a laboratory ball mill in 100 ml NMP. The resulting Li-containing solution and V₂O₃ suspension were combined, 500 mls NMP were added, and the suspension was processed as described in Example 1 above. The final product was a loose (flowable) powder which did not require further milling. The powder from Example 5 was not electrically conductive and was evaluated in the same way as the powder from Example 1, i.e., the electrode composition was 78 wt % powder, 2 wt % carbon black, 15 wt % graphite, and 5% PVDF.

### Examples 6 through 9

Examples 6 through 9 illustrate the effect of changing reaction temperature T₂ on the performance of the LVP powder produced according to process of the present invention.

Twenty gram samples of the powder made in Example 5 were heated at 700° C. (Example 6), 750° C. (Example 7), 800° C. (Example 8), or 900° C. (Example 9) for 10 hours. The powders from Examples 6 through 9 were not electrically conductive and were evaluated in the same way as the powder from Example 1, i.e., the electrode composition was 78 wt % powder, 2 wt % carbon black, 15 wt % graphite, and 5% PVDF.

### Examples 10 and 11

Examples 10 and 11 illustrate the effect of pitch coating and subsequent carbonization on the performance of LVP powders. Fifteen gram samples of the powders made in Example 4 and Example 7 were each coated with about 1.5% pitch and subsequently heat-treated at 800° C. and 850° C. respectively using the methods described in Example 2. Since the resulting coated LVP powders were electrically conductive, they were evaluated in the same way as the powder from Example 2, i.e., the electrode composition was 2 wt % carbon black, 4 wt % graphite, 4 wt % PVDF, and 90 wt % of the powder to be tested.

A comparison of the capacities and coulombic efficiencies at the 1^{st} and 10^{th} cycles for the powders made in Examples 5 through 11 is provided in Table 2.

The data in Table 1 clearly demonstrates that the uncoated Li₃V₂(PO₄)₃ powder from Example 1 has inferior properties (as measured by capacity and initial coulombic efficiency) compared to the carbon-coated powders (CLVP) from Examples 2 and 3. The CLVP powder having a coating of 1.3 wt % pitch (Example 4) exhibits a better capacity than the CLVP powders having a coating of 2.6 wt % or 2.3 wt % pitch (Examples 2 and 3). However, all of the LVP powders (coated and uncoated) exhibited a negligible loss in capacity within 10 cycles.

### Example 12

Example 12 was similar to Example 5 except that the separation of the solid powder from the suspension was performed by filtration instead of evaporation of liquid. 9.68 grams of vanadium trioxide powder (V₂O₃, 95%), 21.08 grams of phosphoric acid (85.5%), and 7.00 gram of lithium carbonate (99.0%) were dispersed and dissolved in 100 ml of 1-methyl-2-pyrrolidinone (NMP). The resulting suspension was transferred into a pressure vessel and heated at 250° C. for 2 hours while the suspension was continuously agitated. After the heat was removed and the suspension cooled to ambient temperature, the suspension was transferred to a filtration funnel and filtered under vacuum to obtain the solid powder. The resulting powder was dried at 100° C. under vacuum. The dried loose powder weighed 26 grams and was slightly green in color, similar to the color of Li₃V₂(PO₄)₃ powder. This powder was further processed by coating it with pitch and subjecting it to a heat treatment in the same manner as described in Example 2. The final powder was evaluated for its electrochemical properties as described above and the results are provided in Table 2.

The data in Table 2 demonstrates that the uncoated LVP materials of Examples 5-9 exhibit better capacity as reaction temperature T₂ is increased, but improvement of the coulombic efficiency appears to reach a maximum level and subsequently declines as the reaction temperature T₂ is increased beyond that which provides maximum efficiency. However, the coated LVP powders in Examples 10-12 exhibit both higher capacity and coulombic efficiency than the uncoated LVP powders of Examples 5 through 9.

TABLE 1
A comparison of the capacities and coulombic efficiencies at the 1^{st} cycle
and the 10^{th} cycle for the samples prepared in Examples 1 through 4

| | | 1^{st} cycle | | 10^{th} cycle | |
|---|---|---|---|---|---|
| | wt % | Capacity | Efficiency | Capacity | Efficiency |
| Example | pitch | (mAh/g) | (%) | (mAh/g) | (%) |
| 1 | — | 69.7 | 88.3 | 69.5 | 97.6 |
| 2 | 2.6 | 118.5 | 94.7 | 118.3 | 99.0 |
| 3 | 2.3 | 117.5 | 95.3 | 118.1 | 99.1 |
| 4 | 1.3 | 124.1 | 95.5 | 124.9 | 99.0 |

TABLE 2
A comparison of the capacities and coulombic efficiencies at the
1^{st} cycle for the samples prepared in Examples 5 through 12.

| | | wt % | 1^{st} cycle | | 10^{th} cycle | |
|---|---|---|---|---|---|---|
| Exam- | T₂ | Pitch/ | Capacity | Efficiency | Capacity | Efficiency |
| ple | (° C.) | Carbon | (mAh/g) | (%) | (mAh/g) | (%) |
| 5 | 650 | — | 100.1 | 91.3 | 99.9 | 98.1 |
| 6 | 700 | — | 107.2 | 92.3 | 107.5 | 99.6 |
| 7 | 750 | — | 113.2 | 94.4 | 112.6 | 99.4 |
| 8 | 800 | — | 115.1 | 92.9 | 108.2 | 98.3 |
| 9 | 900 | — | 121.9 | 91.0 | 121.6 | 99.0 |
| 10 | 850 | ~1.5 | 125.7 | 95.0 | 126.0 | 99.1 |
| | | pitch | | | | |
| 11 | 800 | ~1.5 | 126.0 | 95.5 | 126.8 | 99.3 |
| | | pitch | | | | |
| 12 | 850 | 3.0 | 121.9 | 96.1 | 122.8 | 99.4 |
| | | Carbon | | | | |

Table 2 summarizes the capacities and coulombic efficiencies at the 1st and 10th cycles for the LVP and CLVP powders made in Examples 5-12. The uncoated LVP powders of Examples 5-9 exhibit a lower capacity than the coated LVP powders from Examples 10 and 11, and also have a lower coulombic efficiency at the 1st and 10th cycles than the coated samples. In addition, the specific capacity of the uncoated LVP powders of Example 5-9 dropped slightly from the 1^{st} to 10^{th} cycles whereas that of the carbon-coated LVP powders from Examples 10-12 increased slightly. The increase in the specific capacity of the carbon-coated LVP powders from Examples 10-12 provides evidence supporting the beneficial effect of carbon coating.

The capacity data in Table 1 also indicates that the capacity of the samples barely changed after 10 cycles. FIG. 1 provides a graphic comparison of the capacities at different cycles for the LVP and CLVP from the Examples 1 and 2. Clearly, up to the number of cycles tested, both the samples exhibit a very stable capacity, i.e., there is not any appreciable capacity loss during cycling.

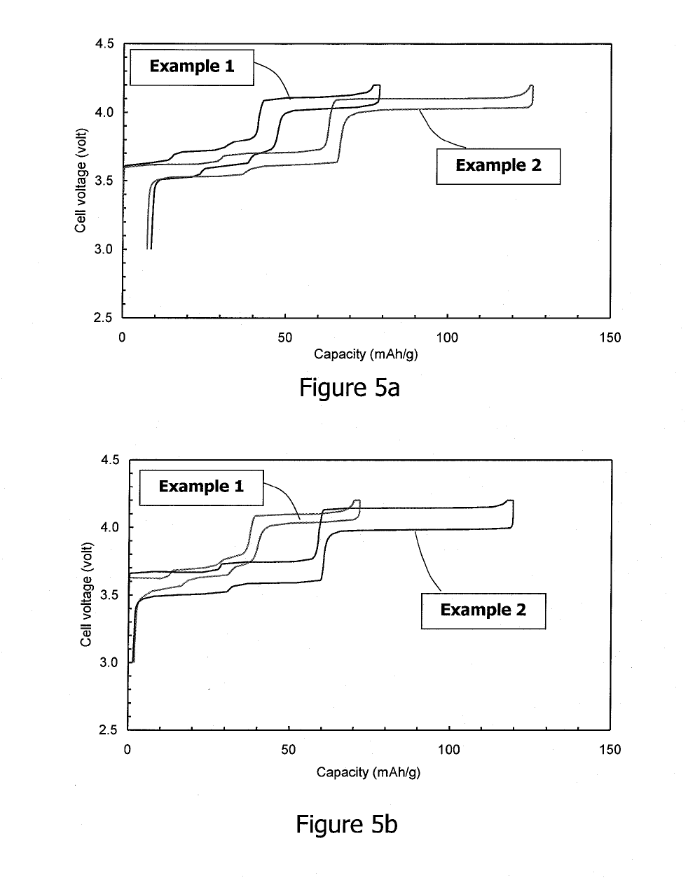

However, as shown in FIGS. 5(a) and (b), the potential profiles of the materials indicate that the particles made in Examples 1 and 2 are comprised of different materials. The LVP of Example 1 exhibits three plateaus between 3.4 and 3.8 volts, whereas the CLVP powder of Example 2 has only two plateaus within the same potential window. The potential profile of the CLVP powder of Example 2 is consistent with that of Li₃V₂(PO₄)₃. Therefore, it appears that the LVP powder of Example 1 is not pure phase Li₃V₂(PO₄)₃ but is an electrochemically active material that is also very stable during cycling. Based on these results, it is possible that a crystallization temperature T₂ of 650° C. may be not be high enough for the formation of pure phase crystalline Li₃V₂(PO₄)₃ in the process of the invention.

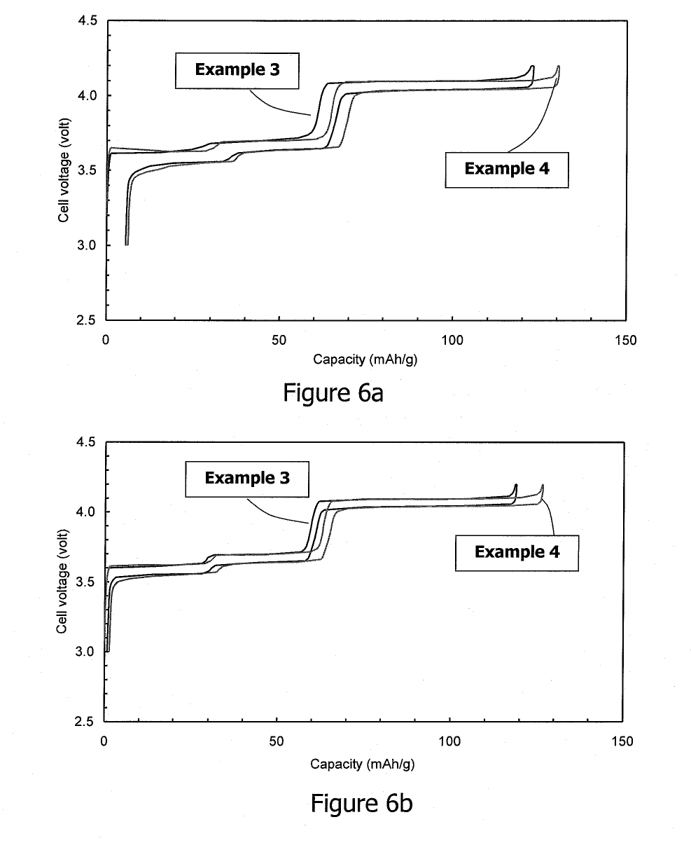

FIGS. 6(a) and (b) show comparisons of the potential profiles at the first and tenth cycles for the CLVP from Examples 3 and 4. The patterns of the potential profiles are exactly the same between the samples and are consistent with those of Li₃V₂(PO₄)₃, however, the CLVP powder from Example 4 exhibits slightly longer potential plateaus than the CLVP powder of Example 3, suggesting that the process of Example 4 resulted in a product which contains more active material per gram than the process of Example 3. Since the only difference between the Examples 3 and 4 is the level of pitch coating (2.3% vs. 1.3%), this result suggests that the presence of an excess amount of carbon may have an adverse effect on the capacity of CLVP powders.

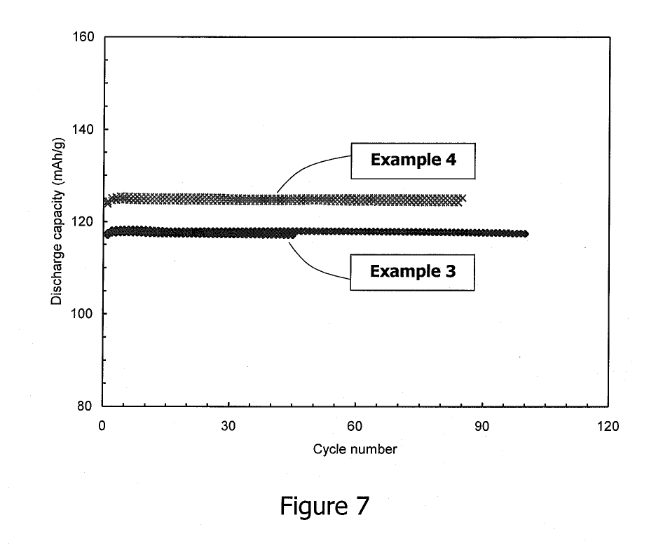

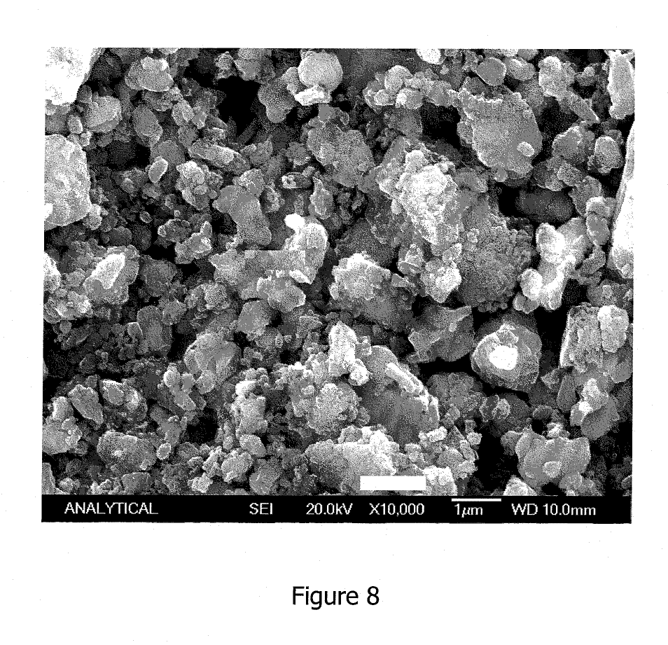

The cycling data for the carbon-coated LVP powders made in Examples 3 and 4 are summarized in FIG. 7. The capacity of the materials increases slightly within initial 5 cycles and then remains nearly constant. After all the tested cycles, ranging from 80 to 100 cycles, the capacity of the materials faded negligibly, less than 0.3 mAh/g. It should be kept in mind that the cycling condition is 100% depth of total capacity for the materials tested. It would be expected that the materials would be perfectly stable if they are cycled at a level less than their total capacity, as would be the situation during normal use.

Thus, it has been illustrated that both plain (uncoated) and carbon-coated Li₃V₂(PO₄)₃ powders can be easily made using inexpensive precursors according to this invention. The usefulness of the process is reflected not only in loose (flowable) powders throughout the process, but also in the superior functionality of the materials produced.

Accordingly, the scope of protection is not limited by the description set out above, but is only limited by the claims which follow, that scope including all equivalents of the subject matter of the claims. Each and every claim is incorporated into the specification as an embodiment of the present invention. Thus the claims are a further description and are an addition to the preferred embodiments of the present invention. The discussion of any reference is not an admission that it is prior art to the present invention, especially any reference that may have a publication date after the priority date of this application.

1. A process for making a lithium transition-metal polyanionic powder comprising the steps of:
a) dispersing and dissolving lithium, transition metal and polyanion precursors in a liquid to form a suspension;
b) heating the suspension to a first reaction temperature (T₁) to cause dissolution of undissolved precursors, reaction of the precursors to form particles of a lithium transition metal phosphate product, and simultaneous precipitation of the solid particles; and
c) separating the solid particles from the suspension solution and drying the precipitate to produce a first particulate powder.

2. The process according to claim 1, further comprising heating the first powder to a second temperature (T₂) that is higher than the first temperature (T₁) to form a crystalline powder, wherein the crystalline powder is comprised of particles of pure phase crystalline LiₓM_{y}(PO₄)_{z}, where M is a transition metal, and x and y are greater than 0.

3. The process according to claim 2, wherein the step of heating the first powder to a second temperature is performed in an inert environment.

4. The process according to claim 2, wherein the second temperature is between 500° C. and 1000° C.

5. The process according to claim 1, wherein the concentration of precursors in the suspension is such that the precipitate formed has a mean particle size of less than 50 microns.

6. The process according to claim 1, wherein the step of separating the solid particles from the solution comprises at least one of filtration, gravity separation and centrifugal separation.

7. The process according to claim 1, further comprising a step of coating the powder with a carbon-residue-forming material.

8. The process according to claim 7, wherein the step of coating the powder with a carbon-residue-forming material comprises a selective precipitation process wherein the amount, molecular weight and melting point of the carbon-residue-forming material which precipitates out of solution and coats the particles is controlled by the selection of carbon-residue-forming material, the solvent used to dissolve the carbon-residue-forming material, the amount of solvent used to dissolve the carbon-residue-forming material and the amount of solvent in the suspension of carbon-residue-forming material and uncoated particles.

9. The process according to claim 7, wherein the coated particles are stabilized by heating the coated particles to a third temperature (T₃) in the presence of an oxidizing agent.

10. The process according to claim 7, further comprising the step of heating the coated particles to a fourth temperature (T₄), said fourth temperature being high enough to carbonize the carbon-residue-forming material coated on the particles and crystallize the particles, wherein the powder is comprised of carbon-coated crystalline LiₓM_{y}(PO₄)_{z} particles, where M is a transition metal, and x and y are greater than 0.

11. The process according to claim 1 where the carbon coating is between about 1 and about 10 weight percent of the solid particles.

12. The process according to claim 11 where the carbon coating is between about 1 and about 3 weight percent of the solid particles.

13. The process according to claim 1 wherein the liquid is selected from water and liquid polar organic compounds, including alcohols, acids, nitrites, amines, amides, quinoline and pyrrolidinones, and mixtures thereof.

14. The process according to claim 1 wherein the lithium precursor is selected from the group consisting of lithium carbonate (Li₂CO₃) and lithium hydroxide (LiOH) and combinations thereof.

15. The process according to claim 1 wherein the step of providing the lithium precursor to the suspension comprises combining vanadium trioxide (V₂O₃) and a liquid solvent.

16. The process according to claim 1 wherein the transition metal precursor comprises vanadium trioxide (V₂O₃) and the vanadium trioxide is milled to an average particle size of less than 30 micrometers prior to step a).

17. The process according to claim 1 wherein step a) further comprises dispersing and dissolving a transition metal precursor in a solvent to form a dispersion, dissolving a lithium precursor and a polyanion precursor in a solvent to form a solution and combining the dispersion with the solution to form the suspension of step a).

18. The process according to claim 1 wherein the first temperature is at least 50° C. and no more than about 400° C.

19. A process of making a finished cathode powder for a battery comprising the steps:
a) dispersing and dissolving a lithium salt, vanadium trioxide (V₂O₃) and phosphoric acid precursors in a liquid to form a suspension;
b) heating the suspension to a first reaction temperature (T₁) to cause dissolution of undissolved precursors, reaction of the precursors to form solid particles of a lithium vanadium phosphate product, and simultaneous precipitation of the solid particles; and
c) separating the solid particles from the suspension solution and drying the precipitate to produce a first particulate powder.

20. A process of making a finished cathode powder for a battery comprising the steps:
a) dispersing and dissolving a lithium salt, vanadium trioxide (V₂O₃) and phosphoric acid precursors in a liquid to form a suspension;
b) heating the suspension to a first reaction temperature (T₁) to cause dissolution of undissolved precursors, reaction of the precursors to form solid particles of a lithium vanadium phosphate product, and simultaneous precipitation of the solid particles;
c) separating the solid particles from the suspension solution and drying the precipitate to produce a first particulate powder;
d) coating the solid particles with a carbon-residue-forming material;
e) stabilizing the coated particles by heating the coated particles to a second temperature (T₂) in the presence of an oxidizing agent; and
f) heating the coated particles to a third temperature (T₃), said fourth temperature being high enough to carbonize the carbon-residue-forming material coated on the particles and crystallize the particles, wherein the powder is comprised of carbon-coated crystalline lithium vanadium phosphate (Li₃V₂(PO₄)₃) particles.
